(19) United States
(12) Patent Application Publication
(10) Pub. No.: US 2009/0192830 A1
(43) Pub. Date: Jul. 30, 2009

(54) Method and system for determining and selecting a longevity benefit payout

(76) Inventor: Mark Shemtob, Denville, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 12/313,437

(22) Filed: Nov. 20, 2008

Related U.S. Application Data
(60) Provisional application No. 61/062,416, filed on Jan. 24, 2008.

(51) Int. Cl. G06Q 40/00

(52) U.S. Cl. 705/4

(57) ABSTRACT

A computer-implemented longevity benefit plan provides that a processor of a computer can determine longevity benefit payouts at respective benefit payment dates that participants of the plan can obtain by use of funds accumulated on behalf of the participants. The accumulated funds are based, in part, from contributions by employers who are sponsors of the plan and where the participants are employed by the employers, or by participants who are members of non-profit organizations which are sponsors of the plan. Based on the amount of funds accumulated as of a predetermined date, such as upon the participant's retirement or attaining a certain age, longevity insurance policies available for purchase for the benefit of the participant having desired longevity benefit payouts payable at respective benefit payment dates can be determined. Alternatively, after the predetermined date, the accumulated funds for the participant can be allocated for investment in a trust to provide for longevity benefit payouts payable directly from the trust at respective benefit payment dates.

### CROSS REFERENCE TO RELATED APPLICATION

This application claims the benefit of the filing date of U.S. Provisional Application No. 61/062,416 filed Jan. 24, 2008, the disclosure of which is hereby incorporated herein by reference

### BACKGROUND OF THE INVENTION

With employers continuing to scale back on defined benefit plans, many employees will not enjoy the security of a lifetime pension benefit to supplement Social Security. Instead, most employees will have an IRA rollover including funds from 401k and other employer qualified plans. Managing the distribution of funds from these rollover accounts will be challenging as a result of unpredictable individual longevity.

Current longevity insurance programs, which provide a payout to a retired individual at a specified date after the retirement of the individual if the retiree survives to the specified date, generally have not been used and are unknown to most of the public. The premiums for such programs typically are relatively high, because a relatively small number of individuals have obtained such insurance and, typically, only individuals in very good health decide to obtain such insurance.

Many employers may consider providing post-retirement age welfare benefits to reward long term employees with insurance that covers the risk of the employee living beyond his or her life expectancy and, as a result, exhausting his or her retirement savings. Employers, however, have not provided retirees with such longevity benefits because of the high price of the premiums, and also the concerns that the employer may be exposed to liability as a fiduciary of the retiree and the programs would be difficult to administer.

Therefore, there exists a need for a longevity insurance plan, sponsored by employers, that provides for ease of selection of a longevity benefit payout by an employee covered by the plan, while avoiding employer liability and also providing an attractive employee-benefit to employer-cost ratio.

### SUMMARY OF THE INVENTION

In accordance with one aspect of the present invention, longevity insurance policies (“LIPs”) that can be purchased for the benefit of participants of a longevity benefit plan are determined by a computer, based on the amount of a longevity benefit accumulation (“LBA”) held in the plan for the participant as of the date of retirement of the participant. The LBA is the accumulation of employer contributions contributed to the plan by the employer of the participant, and in a desired embodiment of employer contributions contributed annually by the employer of the participant as annual employer contributions (“AECs”), and investment earnings on the amount held by the plan for the participant. The determination of the LIPs available for purchase for the benefit of a retired participant from the LBA is performed by a processor of the computer using data representative of the LIPs available for purchase and their respective premiums, where each of the LIPs has a longevity benefit payout payable at a benefit payment date that is a predetermined number of years after the retirement date of the retired participant, and the longevity benefit payout is paid only if the retired participant is alive on the benefit payment date. The determination further is based on the retired participant's gender and date of birth, and desired longevity benefit payout(s) of LIP(s) having respective benefit payment date(s) supplied by the retired participant.

In a further embodiment, a determination of LIPs expected to be available for purchase for the benefit of a participant upon retirement can be performed using an expected LBA computed from actual and estimated employer contributions for the participant, and in a desired embodiment from actual and estimated AECs, and actual and estimated investment earnings on the amount actually and estimated to be held in the plan for the participant, and based on data representative of LIPs expected to be available for purchase at a future date.

In a further aspect of the invention, expected longevity benefit payouts payable to participants of a longevity benefit plan are determined by a computer, where the plan provides that funds accumulated in the plan for the participants, based on employer contributions and investment earnings on the accumulating funds for the respective participants, as of the date of retirement of the participants, or longevity account balances (“LABs”), are invested with the plan. The expected longevity benefits payable to a retired participant at future benefit payment dates are paid directly from the plan to the retired participant, so long as the retired participant is alive on the benefit payment date. A determination of the expected longevity benefits payable to a retired participant can be determined by a processor of the computer from allocations of the LAB of the retired participant, as of the date of the participant's retirement, invested in the trust and respective benefit payment dates for the allocations of the LAB; and be based on gender-based mortality information; an assumed rate of future investment return; a share of a remaining amount of a LAB held in the plan for a retired participant who died prior to a benefit payout date (“deceased retired participant”) selected by the deceased retired participant, or retiree mortality gains (“RMG”), estimated to be held in the plan on behalf of the retired participant; and the date of birth and gender of the retired participant.

In one embodiment, the retired participant can select a beneficiary to receive the longevity benefit payout at the corresponding benefit payment date, in the event the retired participant is dead and the selected beneficiary is alive on the benefit payment date.

In another aspect of the invention, a non-profit organization is a sponsor of a longevity benefit plan, and members of the organization can become participants of the plan. The members of the organization, as participants of the plan, can contribute contributions to the plan, such as annually, quarterly or monthly, to accumulate funds on their behalf. Upon the participants satisfying age-related criteria, such as attaining a certain age or having been a member of the organization for a predetermined number of years, the accumulated funds can be used for purchase of LIPs, or can be invested directly with the plan, for the benefit of the participants.

### BRIEF DESCRIPTION OF THE DRAWINGS

Other objects and advantages of the present invention will be apparent from the following detailed description of the present preferred embodiments, which description should be considered in conjunction with the accompanying drawings in which like reference indicate similar elements and in which:

FIG. 1 is a block diagram of a system in accordance with an aspect of the present invention.

FIG. 2 is a block diagram of an exemplary embodiment of the system of FIG. 1.

FIG. 3 is a flow diagram of a process in accordance with an aspect of the present invention.

FIG. 4 is a flow diagram of a process in accordance with an aspect of the present invention.

FIG. 5 is a flow diagram of a process in accordance with an aspect of the present invention.

### DETAILED DESCRIPTION

For purposes of describing the method and system for determining and selecting a longevity benefit payout payable to a participant of a longevity benefit plan, in accordance with aspects of the present invention in which the plan is sponsored by employers and the participants are employed by or have retired from the employ of the employers, the following definitions of terms are provided.

### Definitions

Participant: An individual who (i) has retired from the employ of a sponsor of a longevity benefit plan, or (ii) is currently a non-terminated and unretired employee of a sponsor of a longevity benefit plan.

Longevity benefit plan: A trust qualified to accumulate funds for a plurality of participants while each of the participants is employed by a sponsor of the plan. Multiple sponsors can participant in a plan. Upon retirement of the participant from the employ of a sponsor of the plan, the accumulated funds held on behalf of the participant in the trust (i) can be used to purchase, for the benefit of the retired participant, a longevity insurance policy having a longevity benefit payout payable on a benefit payment date, or (ii) can be allocated for investment by the trust to generate longevity benefit payouts to be paid from the trust and payable on respective benefit payment dates.

Employee: An individual who is currently employed by a sponsor.

Sponsor: An organization or business entity having employees and qualified to offer a longevity benefit plan to its employees.

Longevity insurance policy (“LIP”): A contract issued for a retired participant by an insurance company that guarantees a longevity benefit payout at a benefit payment date.

Premium rate for an LIP: The rate used by an insurance company selling a LIP to a longevity benefit plan for determining the amount of longevity benefit payout at a benefit payment date that can be purchased for the benefit of a retired participant for each dollar of premium.

Longevity benefit payout: The benefit payable to a retired participant, or a beneficiary elected by the retired participant, at a benefit payment date selected by the retired participant.

Benefit payment date: A date selected by a retired participant that is not sooner than a predetermined number of years following the date of retirement of the retired participant, and on which a payment of a longevity benefit payout is paid to the retired participant if the retired participant is alive, or to a beneficiary optionally elected by the retired participant if the retired participant is deceased and the beneficiary is alive.

Beneficiary: An individual, elected at the option of a retired participant, who will be deemed to be the retired participant if the retired participant is dead and the elected individual is alive on a benefit payment date selected by the retired participant.

Annual Employer Contribution (“AEC”): An amount annually contributed to a longevity benefit plan for a participant by the sponsor employing the participant.

Annual Investment Credit (“AIC”): An annual investment earning credited to accumulating funds of a participant in a longevity benefit plan, prior to the retirement of the participant.

Longevity benefit accumulation (“LBA”): An amount accumulated in a longevity benefit plan for a participant, based on AECs contributed and the AICs credited to the plan for the participant.

Date of retirement: A date at which a participant has ceased, or is expected to cease, employment with the sponsor who is contributing AECs for the participant to the plan, and after which the participant can no longer be credited with any AEC contributions from the sponsor and AICs.

Retiree Mortality Gain (“RMG”): The longevity account balance held in trust for, and attributable to, a retired participant at the death of the retired participant, or the death of a beneficiary elected by the retired participant, where the date of death of the retired participant or the elected beneficiary is before a benefit payment date(s) of a longevity benefit payout, which is for an allocation of the longevity account balance for the retired participant and which is payable from the trust of the plan to the retired participant or the elected beneficiary.

Longevity account balance (“LAB”): An accumulation of AECs and AICs for a participant up to the date of retirement of the participant and any share of RMGs in the plan credited to the retired participant, adjusted by net investment earnings on the accumulation in the years following the retirement of the participant.

Terminated participant: A participant who is no longer an employee of a sponsor and is not a retired participant.

Retired participant: A participant who has worked as an employee of the sponsor up to his or her date of retirement.

An exemplary longevity benefit payout system, in accordance with aspects of the invention, provides that a longevity benefit plan can be established where employers contribute funds to the plan on behalf of employees who are qualified to become participants of the plan and, upon retirement of the participant, (i) at least one longevity insurance policy can be purchased for the benefit of the participant using the funds accumulated in the plan for the participant, which include interest earnings, and where the longevity insurance policy has a longevity benefit payout payable at a future benefit payment date so long as the retired participant is alive on such date; or (ii) a portion of the funds accumulated in the plan for the participant, as of the retirement date of the participant, can be allocated for investment by the plan, such that the sum of the allocated portion, any retiree mortality gains credited to the participant, and investment earnings, from the date of retirement until a benefit payment date, on the allocated portion and the retiree mortality gains credited to the retired participant, is a longevity benefit payout payable to the retired participant at a future benefit payment date, so long as the retired participant is alive on such date.

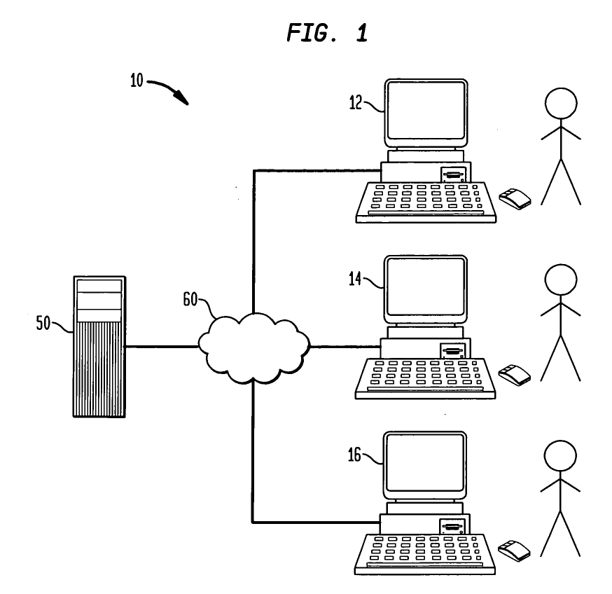

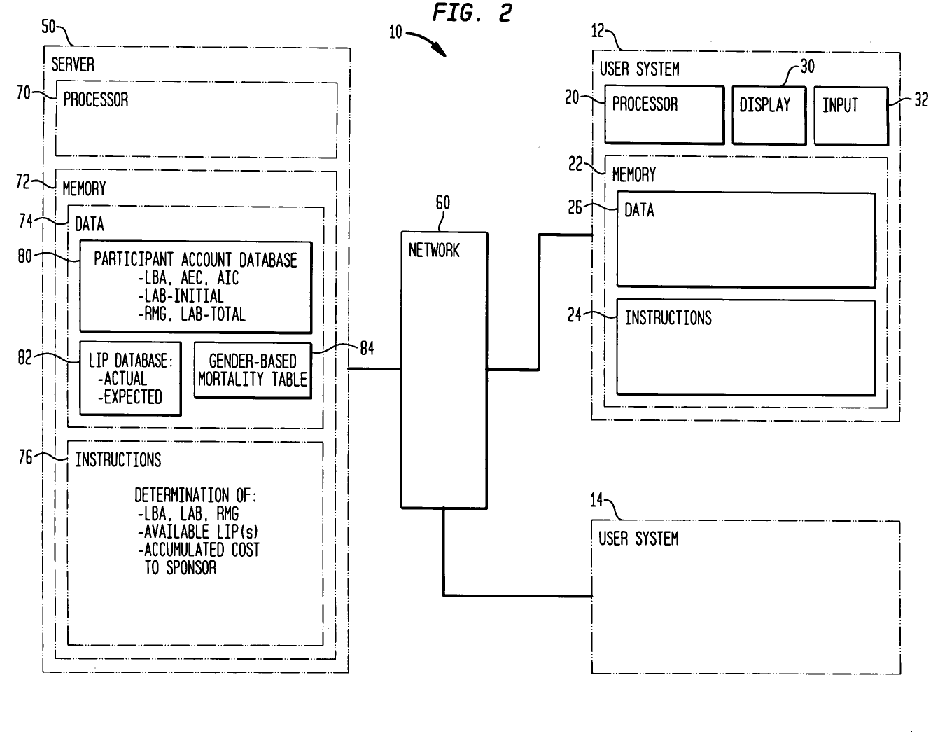

In accordance with one aspect of the invention and as shown in FIGS. 1 and 2, a longevity benefit payout determination and selection system 10 can provide for administration of a longevity benefit plan including a plurality of participants employed by or retired from a plurality of sponsors of the plan. The system includes client computers 12, 14, 16, which are used by sponsors or participants to communicate with a server computer 50 over a communication network 60. Each of the computers 12, 14, 16 contains a processor 20, memory 22 and other components typically present in general purpose computers. In addition, the server 50 contains a processor 70 and a memory 72.

Memory 22 stores information accessible by processor 20, including instructions 24 that may be executed by the processor 20 and data 26 that may be retrieved, manipulated or stored by the processor. Similarly, memory 72 stores information accessible by processor 70, including instructions 76 that may be executed by the processor 70 and data 74 that may be retrieved, manipulated or stored by the processor 70. The memory may be of any type capable of storing information accessible by the processor, such as a hard-drive, memory card, ROM, RAM, DVD, CD-ROM, write-capable, read-only memories.

The processors 20, 70 may comprise any number of well known processors, such as processors from Intel Corporation. Alternatively, the processors may be a dedicated controller such as an ASIC.

The instructions 24, 76 may comprise any set of instructions to be executed directly (such as machine code) or indirectly (such as scripts) by the processors 20, 70, respectively. In that regard, the terms “instructions,” “steps” and “programs” may be used interchangeably herein. The instructions may be stored in object code form for direct processing by the processor, or in any other computer language including scripts or collections of independent source code modules that are interpreted on demand or compiled in advance. The functions, methods and routines of instructions in accordance with the present invention are explained in more detail below.

Data 26, 74 may be retrieved, stored or modified by processors 20, 70 in accordance with the instructions 24, 76, respectively. The data may be stored as a collection of data. For instance, although the invention is not limited by any particular data structure, the data may be stored in computer registers, in a relational database as a table having a plurality of different fields and records, XML documents, or flat files. The data may also be formatted in any computer readable format such as, but not limited to, binary values, ASCII or EBCDIC (Extended Binary-Coded Decimal Interchange Code). Moreover, the data may comprise any information sufficient to identify the relevant information, such as descriptive text, proprietary codes, pointers, references to data stored in other memories (including other network locations) or information which is used by a function to calculate the relevant data.

Although the processor and memory are functionally illustrated in FIGS. 1 and 2 within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

In one embodiment, each client computer may be a general purpose computer, intended for use by a person, having all the internal components normally found in a personal computer such as a central processing unit (CPU) , display 30, input 32 such as a CD-ROM drive, mouse, keyboard or microphone, and a hard-drive, speakers, modem and/or router (telephone, cable or otherwise) and all of the components used for connecting these elements to one another. Moreover, computers in accordance with the systems and methods described herein may comprise any device capable of processing instructions and transmitting data to and from humans and other computers, including network computers lacking local storage capability, PDAs with modems and Internet-capable wireless phones. Although the only input means shown in FIG. 1 are the mouse, keyboard and microphone, other means for inputting information from a human into a computer are also acceptable such as a touch-sensitive screen, voice recognition, etc.

The server 50 and the client computers 12, 14, 16 are capable of direct and indirect communication, such as over the network 60. Although only a few client computers and a single server are depicted in FIGS. 1 and 2, it should be appreciated that a typical system can include a large number of connected computers and several servers to which the computers can connect, with each different computer being at a different node of the network. The network, and intervening nodes, may comprise various configurations and protocols including the Internet, intranets, virtual private networks, wide area networks, local networks, private networks using communication protocols proprietary to one or more companies, Ethernet, WiFi and HTTP. Such communication may be facilitated by any device capable of transmitting data to and from other computers, such as modems (e.g., dial-up or cable), networks and wireless interfaces. In one embodiment, the server 50 may be a web server. Although certain advantages are obtained when information is transmitted or received as noted above, other aspects of the invention are not limited to any particular manner of transmission of information. For example, in some aspects, the information may be sent via a medium such as a disk, tape, CD-ROM.

The information may also be transmitted over a global or private network, or directly between two computer systems, such as via a dial-up modem. In other aspects, the information may be transmitted in a non-electronic format and manually entered into the system.

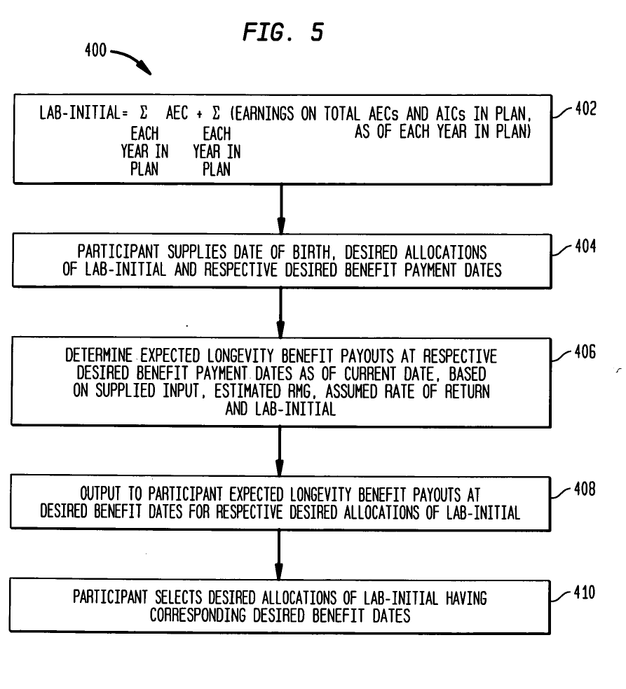

Referring to FIG. 2, the data 74 in the server 50 includes a participant account database 80 containing employer contributions contributed by employers, which contributions desirably can be annually or quarterly, and interest credits, such as interest credits determined annually, for a participant of a longevity benefit plan for each plan year, and longevity benefit accumulation (“LBA”) values for each of the participants. As discussed below, the amount of the LBA at the date of retirement of the participant can be used to purchase for the benefit of the retired participant one or more longevity insurance policies (“LIPs”). In addition, the database 80 includes longevity account balances as of the retirement date of a participant (“LAB-initial”). As discussed in further detail below in the text accompanying the description of FIG. 5, in one aspect of the invention, the retired participant can allocate the LAB-initial for investment by the trust for payment of longevity benefit payout(s) from the trust at respective benefit payment dates. Further, the database 80 includes the total RMG attributed to retired participants who died during a particular year of the plan and the total amount of the LABs for all of the retired participants in the plan during each year of the plan. The data 74 also includes a LIP database 82 containing premiums for existing LIPs having various benefit payment dates and longevity benefit payouts at the respective benefit payment dates, and also expected premiums for LIPs expected to be available at a future date and having various benefit payment dates and expected longevity benefit payouts at the respective benefit payment dates. Further, the data 74 includes a gender-based mortality table 84 containing statistical data concerning the expected mortality of males and females.

The instructions 76 can contain instructions that the processor 70 can execute to determine an LIP available for purchase for the benefit of a retired participant of a plan, or expected to be available for purchase for the benefit of a participant of a plan upon retirement, using data from the databases 80 and 82 and input supplied by the participant. In addition, the instructions 76 can contain instructions that the processor 70 can execute to determine an accumulated cost to an employer for being a sponsor of the plan and contributing to the plan for a participant who had been an employee of the sponsor, where the accumulated cost would be determined upon (i) payment of a longevity benefit payout to the retired participant, or (ii) transfer of ownership to the retired participant of an LIP purchased for the benefit of the retired participant. Further, the instructions 76 can contain instructions that the processor 70 can execute to determine for a participant, before or after retirement as applicable, LAB-initial, the LAB as of the current date, and the expected LAB for a date subsequent the current date, such as a benefit payment date, for an allocation of the LAB-initial of the participant, based on data from the databases 80 and 84 and input supplied by the participant.

In addition to the operations illustrated in FIGS. 1-2, operations in accordance with a variety of aspects of the inventive method will now be described. It should be understood that the following operations do not have to be performed in the precise order described below. Rather, various steps can be handled in reverse order or simultaneously.

In accordance with one aspect of the invention, an employer sponsored longevity insurance program can provide that, upon retirement of a participant of a longevity benefit plan, a longevity benefit accumulation held in a trust administered by the plan on behalf of the participant as of date of the retirement of the participant can be used to purchase one or more longevity insurance policies for the benefit of the retired participant, each of the longevity insurance policies having a longevity benefit payout payable to the retired participant at a future benefit payment date, where the benefit payout is paid to the retired participant so long as the retired participant is alive on the benefit payment date.

In one embodiment, an employer can become a sponsor of a longevity benefit plan by adopting formal plan procedures and rules. The rules, for example, provide that an employee of a sponsor is eligible to participate in the plan, and thus become a participant, if the following conditions are satisfied: the employee (a) has completed three years of employment with the sponsor; (b) attained the age of twenty-one (21); (c) is not a temporary or seasonal employee; (d) is scheduled to regularly work at least 1000 hours per year; (e) is not covered by a collective bargaining agreement; and (f) is not a resident alien. An employee who becomes a participant and subsequently does not satisfy the provisions of either c, d, e, or f is a terminated participant. In addition, the plan rules can provide that an employee, upon satisfying all requirements for being covered under the plan, becomes a participant of the plan as of the first day of the next following plan year. For convenience and ease of explanation of the aspects of the invention, a plan year of a longevity benefit plan begins on January 1, although it is to be understood that a plan year can begin on any day of the year. A retired participant remains a participant under the plan until all of the funds accumulated in the plan on behalf of the participant are a) used to purchase one or more longevity insurance policies for the benefit of the participant; b) paid from the plan to the retired participant; or c) treated as a retiree mortality gain by the plan, based on the death of the retired participant prior to a benefit payment date for a longevity benefit payout payable from the trust to the retired participant.

In a further embodiment, in the event a terminated participant is rehired by an employer, or has incurred a change in employment status that would now permit participation in the plan, he or she is a participant as of the date of his rehire or change in employment status. In still another embodiment, to the extent that an employee is rehired, for example, prior to the completion of 2 years since his or her date of termination from an employer, where the employee had not previously satisfied the requirements to become a participant, prior years of employment with the employer are included in determining eligibility of the employee to become a participant.

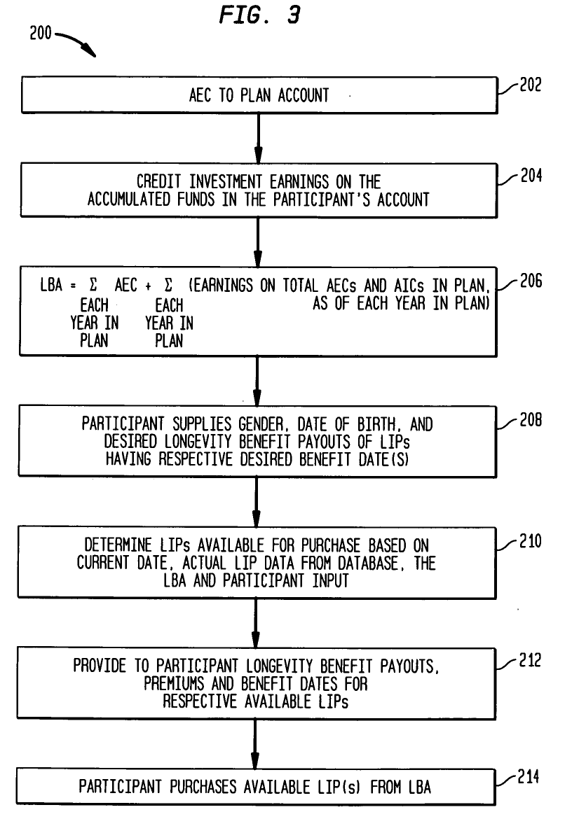

FIG. 3 illustrates steps of an exemplary method 200 for determining an LIP for selection, and selecting of the LIP, by a participant of a longevity benefit plan, based on operations performed by the server 50 and interaction between the computers 12 and 14 and the server 50 of the system 10. It is assumed, for example, that multiple employers are sponsors of the plan and that each employer employs one or more employees who are participants of the plan. Referring to FIG. 3, in block 202 on an annual basis the employer (sponsor) can contribute, such as by the sponsor communicating with the sever 50 using the client computer 12, an annual employer contribution (“AEC”) to a trust maintained by the plan for each employee who is a participant of the plan, where the trust is desirably maintained at and administered by the server 50. It is to be understood that, in accordance with the present invention, the contributions by the employer for an employee who is participant of the plan can be made at other predetermined times, such as quarterly or monthly, and the description of embodiments of the invention below, using contributions annually contributed by the employer, or AECs, is exemplary.

The server 50 stores in the database 74 data representative of the AECs to be credited to accounts of the respective participants of the plan that have been established in the trust, for example, upon transfer of funds of the sponsor from a third party, such as a bank, to the trust of the plan. The AEC contributed by a sponsor can depend upon the age or compensation of the participant, or other factors determined by the sponsor. For example, the AEC is $300 for a participant under age 40, the AEC is $600 for a participant between the ages of 40 and 60, and the AEC is $900 for a participant over the age of 60. In one embodiment, the age of the participant is determined as of the last day of a plan year, or December 31. An AEC is not made to the plan in a plan year for a terminated participant. In another embodiment, for a retired participant, the AEC contributed for the plan year is proportionate to the period of employment between the first day of the plan year and date of retirement of the participant in relation to the length of the year.

In block 204, a determination is made by the processor 70 of the server 50 at a predetermined time, and in a desired embodiment annually, of the interest to be credited to each participant's account, and the processor 70 can desirably store annual interest credit (“AIC”) values in the database 74 for crediting to the accounts of the respective participants accordingly. It is to be understood that, in accordance with the present invention, the interest credits can be determined at other predetermined times, such as quarterly or monthly, and the description of embodiments of the invention below, using interest credits determined annually, is exemplary.

In one embodiment, the plan provides for a variable interest rate corresponding to the actual rate of return, such that the amount credited for each participant's account is based on the actual rate of return for the trust, less any expenses paid from the trust for administrative and other required services. In another embodiment, the plan provides for a guaranteed interest rate, such that the amount credited for each participant is determined based on the applicable guaranteed interest rate.

In one embodiment, the amount to be credited to each participant in block 204 is calculated as of the last day of the plan year, and is equal to that amount, when credited proportionally to each participant of the plan as of the first day of the plan year, which will equal in aggregate the net investment earnings of the trust for the plan year. AICs will not be applied to amounts of forfeitures for the plan year. In the case where a participant became a retired participant during the plan year, the AIC is determined based on the period between the first day of the plan year and the last day of the month in which the participant retired. In one embodiment, the amount of funds in the account of a terminated participant is forfeited as of the second anniversary of the date that the employee becomes a terminated participant. Once a forfeiture occurs, the funds contributed for the terminated participant are not reinstated, and the contributed funds, including any investment earning on the contributed funds can be used to offset any current contribution obligations to the plan of a sponsor who is obligated to contribute to the plan.

In block 206, a determination is made by the processor 70, desirably on an annual basis or when a request is received from a sponsor or participant, of the total AECs and AICs for each participant, using the data stored in the database 74, where the total constitutes the longevity benefit accumulation (“LBA”) for the participant as of the date of the determination. In one embodiment, the sponsor at the client 12, or a participant at the client 14, can obtain a detailed individual report on the LBA from the server 50.

Once a participant has become a retired participant, the retired participant can, through interaction with the server 50 via the client 14, have the processor 70 determine one or more LIPs available for purchase for the benefit of the participant. The LIPs can be purchased for the benefit of the retired participant using the amount of the LBA of the participant as of the date of retirement. In one embodiment, in block 208, the retired participant, after accessing his or her account information from the server 50 using the client computer 14, supplies input information including gender and date of birth, and also one or more desired longevity benefit payouts by LIPs having respective benefit payment dates. In the event multiple LIPs are purchased for the benefit of the retired participant from the funds contained in the participant's LBA, the retired participant can obtain from the LIPs a stream of longevity benefit payouts over multiple benefit payment dates. In one embodiment, a benefit payment date is at least fifteen years after the date of retirement of the participant.

In block 210, the processor 70 retrieves actual LIP data from the database 82. The actual LIP data include LIPs available for purchase on the date on which the retired participant is requesting information (“current date”) on LIPs available for purchase, the longevity benefit payouts payable at respective benefit payment dates by such available LIPs and the premiums for purchase of such available LIPs as of the current date. The actual LIP data is, for example, supplied to the server 50, over the network 60, from various third party insurance companies that provide longevity benefit insurance and offer to sell such LIPs for the benefit of the retired participants of the plan. The actual LIP data can be updated periodically, based on the server 50 obtaining such updated information electronically from the third parties. The purchase of an LIP for the benefit of a retired participant is funded with a single premium paid from the retired participant's LBA and results in payment of a longevity benefit payout to the retired participant on its benefit payment date, provided the retired participant survives to the benefit payment date. In one embodiment, the premiums are determined based on data tables furnished by insurance companies that sell longevity insurance policies, and the tables are based upon expected mortality, gender and age, interest, and expense factors that are set by the insurance company. Based on the actual LIP data; the LBA of the participant as of the date of retirement, which is retrieved from the database 74; the gender, date of birth and desired benefit payouts with respective benefit payment dates supplied by the participant (block 208), the processor 70 determines LIPs available for purchase for the benefit of the participant on the current date whose benefits and respective payment dates match or substantially correspond to those provided by the participant.

In block 212, the LIPs available for purchase for the benefit of the retired participant determined in block 210, including their respective benefit payouts, benefit payment dates and premiums, are transmitted by the server 50 to the client 14 for rendering in the form of a report or display, which can be saved or printed.

Then in block 214, the retired participant can decide whether the identified LIPs are satisfactory or consistent with his objectives. If they are not, the retired participant can alter the desired longevity benefit payout and benefit payment date inputs, as supplied in block 208, so that the processor 70 determines other, different LIPs available for purchase based on the changed benefit payouts and benefit payment date inputs. For example, the retired participant can supply new inputs where the sum of the premiums for the identified LIPs is not equal to the LBA. The retired participant can continue to supply different inputs, as many times as desired, to obtain a new set of available LIPs. In another embodiment, the server 50 provides that the retired participant can cause the processor 70 to modify the benefit payouts for a set of identified LIPs so that the sum of their premiums equals the LBA. After the sum of the premiums of the identified LIPs equals the LBA of the retired participant, the retired participant can supply input at the client 14 to effectuate the purchase of the available LIPs identified in block 212, using the funds from the LBA of the retired participant.

In block 214, when the retired participant supplies input at the client 14 providing for the purchase of LIPs identified in block 212, the premiums for the identified LIPs are deducted by the processor 70 from the LBA of the retired participant, desirably such that the LBA becomes zero. As discussed above, the retired participant must survive to the benefit payment date of an LIP in order to receive the longevity benefit payout of the purchased LIP.

An exemplary implementation of the method 200 is described below. It is assumed that on Jan. 1, 2029, a male participant of a longevity benefit plan, which provides for purchase of LIPs from the LBA of the participant, retires at age 65. It is further assumed that the participant has been covered by the plan for 20 years, and that, for each year that the participant was covered by the plan, the participant was credited with an annual contribution of $1000 made by his employer. In addition, it is assumed that the contributions were invested in a trust fund and had been earning interest, such that at age 65, the sum of the contributions plus investment earnings totaled $35,000 for the participant. Upon retirement, the retired participant would, via the client computer 14, access a website hosted by the server 50, and the website would include applications that allow the retired participant to determine available LIPs that can be purchased, which have desired longevity benefit payouts and corresponding benefit payment dates supplied by the retired participant. The retired participant would supply the following information to the server 50 via the website: gender (male); date of birth, which for the example is Jan. 1, 1964; and benefit payment dates for receipt of desired longevity benefit payments, which are as follows: on Jan. 1, 2044, $50,000; on Jan. 1, 2045, $55,000; on Jan. 1, 2046, $60,000; on Jan. 1, 2047, $65,000 and on Jan. 1, 2048, $70,000. The processor 70 would retrieve the LBA for the retired participant, which is $35,000, and also the premium information for the actual LIPs available as of the current date, which is Jan. 1, 2029, and determine, based on the information supplied by the participant and the retrieved information, the details of LIPs available for purchase, and then transmit such information to the client for display in report form by the browser of the client 14 as follows:

TABLE I

| Benefit | Longevity Benefit | |
|---|---|---|
| Payment Date | Payout ($) | Premium ($) |
| Jan. 1, 2004 | 50,000 | 7,000 |
| Jan. 1, 2045 | 55,000 | 6,700 |
| Jan. 1, 2046 | 60,000 | 6,500 |
| Jan. 1, 2047 | 65,000 | 6,200 |
| Jan. 1, 2048 | 70,000 | 6,000 |

As the total premium for the available LIPs determined by the server 50 is $32,400, the participant has $2,600 ($35,000 (LBA)−$32,400) available to provide additional benefits. In one embodiment, the retired participant may then supply alternative desired benefit payouts and benefit payment dates so that different available LIPs may be determined by the processor 70. In another embodiment, the retired participant can decide to have the benefit payouts of a set of identified available LIPs modified proportionally by the processor 70, so that the entirety of the LBA of the retired participant is used to purchase the identified available LIPs.

In a further embodiment, the plan can provide that a retired participant can elect a beneficiary to receive a longevity benefit payout of an LIP, in the event the retired participant does not survive to the benefit payment date of the LIP and the beneficiary is alive on the benefit payout date. In such embodiment, the retired participant must specify a beneficiary within a predetermined time of the date of retirement, and once specified the beneficiary cannot be changed. If the beneficiary is specified, in block 208 of the method 200, the retired participant further supplies the gender of the beneficiary and the date of birth of the beneficiary. In addition, in block 210, the actual LIP data retrieved by the server include premium information of actual LIPs providing for election of a beneficiary to receive the longevity benefit payouts.

In a further embodiment, in the event an LIP purchased for the benefit of a retired participant is transferred to the retired participant, the server 50 can provide that a portion of the LBA for the retired participant is liquidated and a cash distribution is made to the retired participant.

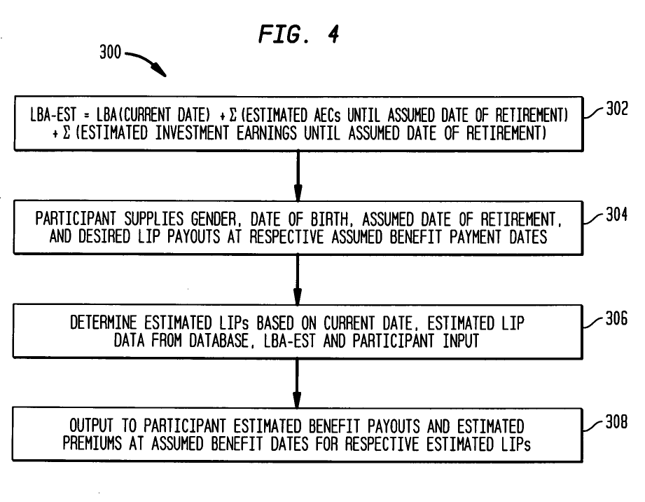

In another aspect of the invention, as illustrated in FIG. 4, the processor 70 of the server 50 can execute a process 300 to determine for a participant of a plan, who has not yet attained retirement, one or more LIPs estimated to be available for purchase for the benefit of the participant upon retirement of the participant. The server 50 maintains a record of AECs and the AICs for the participant, as in blocks 202 and 204 of the process 200. In block 302, the processor 70 computes an estimated LBA (“LBA-est”) as of an assumed date of retirement for the participant. LBA-est is equal to the sum of (i) the LBA for the participant accumulated as of the current date; (ii) the AECs estimated to be contributed between the year of the current date and the year of the assumed date of retirement; and (iii) the estimated investment earnings, for each year between the year of the current date and the year of the assumed date of retirement, on the sum of (a) the estimated AEC for a subject year between the year of the current date and the year of the assumed date of retirement and (b) the sum of the LBA as of the current date, the AECs estimated to have been contributed through the end of the subject year and the total actual and estimated investment earnings for the participant as of the beginning of the subject year. In one embodiment, an estimated AEC is the same as the last contributed AEC. In an alternative embodiment, an estimated AEC for a subject year is adjusted based on assumed periodic adjustments to the AECs based on inflation. In a further embodiment, an estimated investment earning is determined based on an estimated annual rate of return supplied by the participant. In another embodiment, the plan specifies an annual rate of return and such rate is used as the estimated annual rate of return for determining an estimated investment earning each year between the year of the current date and the assumed year of the date of retirement.

In block 304, the, participant, similarly as in block 208, supplies input information including gender and date of birth, and also one or more desired longevity benefit payouts for LIPs estimated to be available at the participant's retirement and having respective assumed benefit payment dates.

In block 306, the processor 70 retrieves estimated LIP data from the database 82. The estimated LIP data include LIPs estimated to be available for purchase at the assumed date of retirement of the participant, and the estimated longevity benefit payouts payable at respective assumed benefit payment dates for the estimated LIPs and estimated premiums for purchase of such estimated LIPs. The estimated LIP data is, for example, supplied to the server 50, over the network 60, from various third party insurance companies that provide longevity benefit insurance and offer to sell such LIPs to the retired participants of the plan. Further in block 306, the processor 70 determines LIPs estimated to be available for purchase at the assumed retirement date of the participant based on the input supplied by the participant at block 304, the estimated LIP data, the current date and the LBA-est determined for the participant.

Then in block 308 the estimated LIPs determined to be available as of the date of retirement of the participant, along with estimated premiums and estimated benefit payouts at the assumed benefit payment dates, are provided to the client 14.

An exemplary implementation of the method 300 is described below. In the example, it is assumed that the participant is a male who plans to retire at age 65 on Jan. 1, 2029. It is further assumed that the participant, on Jan. 1, 2014, is 50 years old and desires to determine what LIPs may be available for purchase upon the retirement of the participant. It is also assumed that the participant has been covered by the longevity benefit plan for 10 years as of Jan. 1, 2014, and that for each year that the participant was covered by the plan, the participant was credited with an annual contribution of $1000 made by his employer. In addition, it is assumed that the contributions for the participant were invested in a trust fund and have been earning interest and, as of the current date, the sum of the contributions plus investment earnings is $15,000. The participant would supply to the server 50 the following information so that the server 50 can determine estimated LIPs that may be available for purchase upon his retirement: his gender (male); his date of birth, which is Jan. 1, 1964; and the desired longevity benefit payouts he would like to receive at assumed benefit payment dates, which are as follows: on Jan. 1, 2044, $50,000; on Jan. 1, 2045, $55,000; on Jan. 1, 2046, $60,000; on Jan. 1, 2047, $65,000 and on Jan. 1, 2048, $70,000. Assuming that future AECs are $1000 and the future rate of return is 5%, the processor 70, following receipt of information from the participant, would determine that the LBA-est as of assumed date of retirement for the participant is $52,762. In other words, the total amount estimated to be available for purchase of LIP(s) for the benefit of the participant, upon retirement, is $52,762. In addition, the processor 70 would determine the LIPs estimated to be available as of the assumed retirement date, based on the estimated premium information for the estimated LIPs and the input supplied by the participant, and transmit the following report for display on the browser of the client 14:

TABLE II

| Benefit | Longevity Benefit | |
|---|---|---|
| Payment Date | Payout ($) | Premium ($) |
| Jan. 1, 2044 | 60,000 | 7,700 |
| Jan. 1, 2045 | 65,000 | 7,300 |
| Jan. 1, 2046 | 70,000 | 6,900 |
| Jan. 1, 2047 | 75,000 | 6,600 |
| Jan. 1, 2048 | 80,000 | 6,200 |

In a further embodiment, the plan can provide that a participant can have the processor 70 of the server 50 determine estimated LIPs where the estimated LIPs permit that the participant can elect a beneficiary to receive a longevity benefit payout of the estimated LIP, similarly as discussed above. In such embodiment, the participant further supplies the gender and date of birth of the beneficiary, and this additional information is used by the processor 70 to determine premiums of LIPs estimated to be available upon the retirement of the participant.

In a further embodiment, a longevity benefit plan can allow a participant to waive his or her right to a longevity benefit payout, thus avoiding the recognition of taxable income by the participant, or to have a portion of his or her LBA used in the satisfaction of the taxable income incurred upon transfer of ownership of an LIP that has been purchased for the benefit of the participant.

In another aspect of the invention, as illustrated by the exemplary process 400 in FIG. 5, participants of a longevity benefit plan can select longevity benefit payouts payable to the participants, following their retirement, from a trust in which AECs and investment earnings on accumulated funds for the participant are held and where the retired participant shares proportionally in any retiree mortality gains (“RMGs”) forfeited to the trust. The employer of the participant, similar to the process 200, makes AECs for the participant to the trust and investment earnings on the accumulated funds are also credited to the trust. For ease of explanation, the remainder of the process 400 is described under the assumption that the participant is a retired participant and the current date is the date of retirement of the participant. In block 402, the processor 70 of the server 50 determines an initial longevity account balance (“LAB-initial”) for the participant, at the date of retirement of the participant, by summing the AECs for the retired participant and, for each year the retired participant was in the plan, the investment earnings on the total AECs and accumulated investment earnings held in the plan for the retired participant as of the subject year.

In block 404, the retired participant supplies input information including date of birth, desired allocations of the LAB-initial and desired benefit payment dates for the respective desired allocations of the LAB-initial.

In block 406, the processor 70 determines expected longevity benefit payouts at the respective desired benefit payment dates supplied by the retired participant. To perform this determination, the processor 70 retrieves gender-based mortality information from the database 84 corresponding to the gender information supplied by the participant. The mortality information is, for example, supplied to the server 50, over the network 60, from various third party sources of such information, such as insurance companies or actuarial tables. In addition, the processor 70 assumes a rate of future investment return and estimates the share of the RMGs to be credited to the retired participant's LAB. A RMG is a remaining amount of a LAB held in the trust for a retired participant who died prior to the desired benefit payment date(s) (“deceased retired participant”) selected by the deceased retired participant and on which the longevity benefit payout(s) was to be paid from the trust. Based on the estimated share of the RMGs to be apportioned to the retired participant from the current date to the benefit payment date(s), which the processor 50 determines according to techniques that allocate the amount of the RMG (i) equally to the LABs of all other retired participants in the plan or (ii) to designated LABs in the plan based on predetermined criteria, such as the date of birth, a classification ascribed to or gender of the retired participant, or whether a beneficiary has been elected by the retired participant, the assumed future rate of return, the LAB-initial, and the date of birth, gender and the LAB-initial allocation information supplied by the retired participant, the processor 70 determines an expected longevity benefit payout(s) to be paid from the trust to the retired participant at the desired benefit payment date(s).

In block 408, the expected longevity benefit payouts determined in block 406 are rendered to the client 14, for display or print out, In block 410 the retired participant suitably selects the desired allocations of the LAB-initial, based on the information supplied in block 408. Similarly as discussed above for the process 200, in one embodiment, the retired participant can supply different input information in block 404, so that other expected longevity benefit payouts are determined in block 406 and rendered to the retired participant in block 408. After the retired participant selects the desired allocations of the LAB-initial, the allocations cannot be changed.

In one embodiment, the actual LAB, as of the first day of the current plan year (“LAB-updated (current year)”), for an allocation of a portion of the LAB-initial that a retired participant had selected, is determined by the processor 70 as follows:

LAB-updated(current year)=LAB-updated(prior year)+0.01*R*LAB-updated(prior year)+LAB-updated(prior year)/LABTotal-updated (prior year)*RMG-total(prior year),

where LAB-updated(prior year) is the total accumulated funds in the trust for an allocation of a portion of the LAB-initial of the retired participant as of the first day of the preceding plan year, R is the actual return on investment for the trust in the preceding plan year, LABTotal-updated (prior year) is the sum of all LAB-updated(prior year) for all allocations of all retired participants in the plan as of the first day of the preceding plan year, and RMG-total(prior year) is the sum of all LAB-updateds(prior year) forfeited in the preceding plan year based on the death of retired participants during the preceding plan year. In the case where the participant in the plan retired in the prior plan year, LAB-updated(current year) for an allocation of a portion of LAB-initial of the participant is equal to the allocation of a portion of LAB-initial for the participant.

In another embodiment, the expected longevity benefit payout (Payout-exp) at the benefit payment date of an allocation of a portion of LAB-initial is determined by the processor 70 iteratively computing values for LAB-updated(current year) from the current year to the year of the benefit payment date, similarly as above, except that an assumed annual rate of return on investment and assumed RMGs are utilized.

An exemplary implementation of the method 400 is described below. In the example, it assumed that the participant is a male who plans to retire at age 65 on Jan. 1, 2029; has been covered by the longevity benefit plan for 20 years; and was credited with an annual contribution of $1000 made by his employer for each year that the participant was covered by the plan. In addition, the contributions were invested in a trust fund and have been making investment earnings, such that at age 65, it is assumed that the sum of the contributions plus investment earnings equals $35,000, or LAB-initial equals $35,000. The participant would access the server 50 to determine what longevity benefit payouts are estimated for desired benefit payment dates, such that the participant can select how much of the LAB-initial to allocate to the respective benefit payment dates to obtain expected longevity benefit payouts directly from the trust. The participant, for example, would supply the following desired allocations of LAB-initial to the server 50: (i) a first benefit payout on Jan. 1, 2044, for which $4,000 of the LAB is allocated; (ii) a second benefit payout on Jan. 1, 2045, for which $5,000 of the LAB is allocated; (iii) a third benefit payout on Jan. 1, 2046, for which $5,000 of the LAB is allocated; (iv) a fourth benefit payout on Jan. 1, 2047, for which $5,000 of the LAB is allocated; and (v) a fifth benefit payout on Jan. 1, 2048, for which $6,000 of the LAB is allocated.

In one embodiment, the processor 70, on an annual basis, starting on Jan. 1, 2030, updates each of the benefit payouts corresponding to the allocations of LAB-initial for the retired participant. Each of the updated benefit payouts, LAB-updated(current year), for the retired participant is determined by the processor 70 based upon the actual investment earnings rate attributable to the pool of assets for retired participants having their LAB-initials with the plan. In addition, the updated benefit payouts reflect RMGs attributable to retired participants who have died during the previous year and thus will not be eligible for a future benefit payment.

In one embodiment, the portion of the RMGs attributable to an updated LAB for the participant is determined as follows. Continuing with the example, at the start of a new year on Jan. 1, 2030, the sum of the LAB-updates for each retired participant in the plan who did not die during the prior year (2029) (“LAB-total”), and RMG-total(prior year) for the plan for the prior year (2029), are determined by the processor 70. For example, RMG-total(prior year) for 2029 is $50,000 and the LAB-total is $400,000. Assuming that the rate of return attributable to assets held for retired participants in the plan is 5%, on Jan. 1, 2030, the benefit for the $4000 allocation of the LAB-initial of the retired participant is equal to: the allocated portion of LAB-initial ($4000) plus the investment gain (0.05*4000 or $200) plus the RMG portion attributable, which is LAB(prior year)/LAB-total*RMG-total ($4,000/$400,000*$50,000 or $500), or $4,700.

In one embodiment, the factors used by the server 50 in estimating RMG credits for a plan year are updated periodically to reflect changes in mortality factors, which may be set forth in the database 84.

In another embodiment, the plan can provide that a retired participant can elect a beneficiary to receive a longevity benefit payout for an allocation of LAB-initial, in the event the retired participant does not survive to the benefit payment date for the allocation of the LAB-initial and the beneficiary is alive on the benefit payout date. In such embodiment, the retired participant must specify a beneficiary within a predetermined time of the date of retirement, and once specified the beneficiary cannot be changed.

In a further embodiment, the sponsor can obtain from the server 50, via the client 12, a report on the accumulated cost to the employer for a participant in the plan when a longevity benefit payout from either an LIP or directly from the trust of the plan has been made to the participant, or alternatively if ownership of an LIP purchased for the benefit of a retired participant is transferred to the retired participant. The processor 70 of the server 50 determines the accumulated cost to the sponsor for the retired participant based on the amount of AECs contributed to the plan by the employer (sponsor), decreased by (i) the amount of AECs contributions by the employer for an employee who had been a participant of the plan but had been terminated prior to the retirement of the participant, such that the AECs for the participant are apportioned to other participants of the employer in the plan, or (ii) any portion of the RMG credited to the trust which corresponds to a cost basis for a retired participant who died prior to the benefit payment date for the retired participant.

In a further embodiment where the plan specifies an annual rate of return for the plan, an employer is required to make an additional contribution to the plan, if needed, to satisfy a specified annual rate of return. In such embodiment, the accumulated cost to the employer is incremented by any additional contribution to the plan by the employer to satisfy the specified annual rate of return for the plan.

In a further embodiment, the server 50 includes instructions that the processor 70 executes and provide that the processor 70 can identify input of inappropriate values by the participant that accesses the server 50 to determine available LIPs or expected benefit payments based on allocations of the LAB-initial.

Thus, advantageously in accordance with aspects of the invention, in a longevity benefit plan implemented by a computer, employers sponsor the plan and make contributions to the plan to accumulate funds payable to employee participants of the plan upon retirement, where the accumulated funds can be used by the participant employees at their retirement (i) for the purchase on their behalf and for their benefit of a longevity insurance policy, or (ii) for investment in the trust of the plan to obtain longevity benefit payments resulting from designated allocations of the accumulated funds and investment earnings on the allocated portions of the accumulated funds and on gains attributable to the retired participants in the plan who never receive benefits because of their death prior to the benefit payment date. The plans can provide guaranteed or variable interest on the contributions made by the sponsor for accumulating the funds that can be used to purchase LIPs or make investments from which longevity benefit payouts are payable at benefit payment dates subsequent to the date of retirement of the employee. The plan further provides that customized reports can be prepared for each covered employee detailing benefits currently earned and those projected to be available at retirement, and further provides that retiring or retired participants of the plan can model the alternative longevity benefit options available under the plan. The plan further can provide a retired participant with the option of electing a beneficiary to receive the retired participant's longevity benefit payout, in the event the retired participant is not alive and the beneficiary is alive on the benefit payment date.

In another aspect of the invention, a longevity benefit plan can be sponsored by a non-profit organization, such as AARP, and members of the organization are participants of the plan and contribute to the plan for accumulating funds on their behalf. Upon the participant having been a member of the sponsoring organization for a predetermined number of years or reaching a predetermined age, (i) LIPs, which have a longevity benefit payout payable at a future benefit payment date so long as the participant is alive on such date, can be purchased for the benefit of the participants from the accumulated funds; or (ii) a portion of the accumulated funds can be allocated for investment by the plan for payment of a longevity benefit payout at a future benefit payment so long as the participant is alive on the benefit payment date. The organization-sponsored plan also can provide for election of beneficiaries, similarly as in the employer-sponsored plans described above.

In one embodiment of a organization-sponsored longevity benefit plan, the LBA for each of the participants of the plan can accumulate funds, and the available LIPs can be determined and then selected by the participants, similarly as described above for the processes 200 and 300, except that (i) each of the participants at predetermined times, such as quarterly or annually, contributes a contribution to the plan, which is held by the plan on behalf of the participants, instead of the employers of the respective participants contributing to the plan; and (ii) the participant must have been in the plan and also simultaneously a member of the sponsoring organization for at least a predetermined number of years, or alternatively attained a predetermined age, before an LIP can be purchased for the benefit of the participant using the LBA of the participant.

In another embodiment a organization-sponsored longevity benefit plan, the LAB for each of the participants of the plan can be accumulated, similarly as described above for the process 400, except that (i) each of the participants at predetermined times, such as quarterly or annually, contributes a contribution to the plan, which is held by the plan on behalf of the participants, instead of the employers of the respective participants contributing to the plan; (ii) the participant must have been in the plan and also simultaneously a member of the sponsoring organization for at least a predetermined number of years, or alternatively attained a predetermined age, before a LAB-initial for a participant of the plan can be determined and then allocated for investment by the plan; and (iii) the portions of the LAB-initial allocated for investment by the plan share mortality gains (“MGs”), rather than RMGs. An MG is an account balance held in trust for, and attributable to, a participant, who had allocated the LAB-initial for investment directly by the trust when the participant had satisfied age-related criteria (“qualifying participant”), at the death of the qualifying participant, or the death of a beneficiary elected by the qualifying participant, where the date of death of the qualifying participant or the elected beneficiary is before a benefit payment date(s) of a longevity benefit payout, which is for an allocation of the longevity account balance for the qualifying participant and which is payable from the trust of the plan to the qualifying participant or the elected beneficiary.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computer-implemented method for selecting at least one longevity insurance policy (“LIP”) having a longevity benefit payout payable to participants of a longevity benefit plan, wherein the plan includes a plurality of participants who are retired employees of at least one employer sponsoring the plan, the method comprising:
for each of the participants of the plan, the employer of the participant contributing employer contributions (“ECs”) to an account of the plan held on behalf of the participant;
crediting the plan account for each of the participants with investment earnings on the amount held in the plan account;
setting a longevity benefit accumulation (“LBA”) for at least a first participant upon retirement of the first participant from an employer sponsoring the plan for use in purchase of an LIP, wherein the LBA is computed by a processor from the sum of the ECs for the first participant and the credited investment earnings for the first participant held in the plan account on behalf of the first participant as of the date the first participant retires;
providing a database of data representative of LIPs available for purchase and respective premiums, each of the LIPs having a longevity benefit payout payable at a benefit payment date, wherein the benefit payment date is a predetermined number of years after the retirement date of the first participant, and wherein the longevity benefit payout is paid to the first participant only if the first participant is alive on the benefit payment date for the LIP;
supplying to the processor, for the first participant, data representative of gender, date of birth, the LBA, at least one desired longevity benefit payout by an LIP and at least one desired benefit payment date for the desired longevity benefit payout; and
determining by the processor, based on (i) data representative of a current date, (ii) the data representative of the premiums for longevity benefit payouts payable at benefit payment dates of the respective LIPs in the database and (iii) the data representative of the LBA, the date of birth, the gender, the desired longevity benefit payout and the desired benefit payment date for the desired longevity benefit payout for the first participant, at least a first LIP available from the database for purchase for the benefit of the first participant.

2. The method of claim 1, further comprising:
supplying to the processor data representative of gender and date of birth of a beneficiary of the first participant; and
wherein the determining by the processor of the first LIP is further based on the data representative of the gender and the date of birth of the beneficiary, wherein the longevity benefit payout of the first LIP is payable by the first LIP to the beneficiary if the beneficiary is alive and the first participant is dead on the benefit payment date for the first LIP.

3. The method of claim 1 further comprising:
following transfer of ownership of the first LIP, or payment of the longevity benefit payout for the first LIP, to the first participant, computing by the processor of an accumulated cost to the employer for the first participant and supplying the accumulated cost to the employer.

4. The method of claim 3, wherein the accumulated cost is a function of an adjustment to the plan account resulting from at least one of (i) a forfeiture of contributions by the employer for an employee who had been a participant of the plan but had been terminated prior to the retirement of the participant, or (ii) an additional contribution to the plan by the employer to satisfy a specified annual rate of return for the plan.

5. A computer-implemented method for selecting at least one longevity insurance policy (“LIP”) having an estimated longevity benefit payout payable to participants of a longevity benefit plan, wherein the plan includes a plurality of participants who are non-terminated and unretired employees of at least one employer sponsoring the plan, the method comprising:
for each of the participants of the plan, the employer of the participant contributing employer contributions (“ECs”) to an account of the plan held on behalf of the participant;
crediting the plan account for each of the participants with investment earnings on the amount held in the plan account;
setting an estimated longevity benefit accumulation (“LBA”) for at least a first participant upon retirement of the first participant from an employee sponsoring the plan for use in purchase of an LIP, wherein the estimated LBA is computed by a processor from the sum of actual and estimated
plan holdings for the first participant, wherein the actual plan holdings is computed by the processor from the sum of the ECs for the first participant and the credited investment earnings for the first participant held in the plan account on behalf of the first participant as of the date the estimated LBA is set for the first participant, and
wherein the estimated plan holdings is computed by the processor from the sum of estimated ECs for the first participant and estimated credited investment earnings for the first participant from the date the estimated LBA is set to an assumed date of retirement for the first participant;
providing a database of data representative of LIPs estimated to be available for purchase at the assumed date of retirement for the first participant and respective estimated premiums, each of the LIPs having a longevity benefit payout payable at a benefit payment date, wherein the benefit payment date is a predetermined number of years after the assumed date of retirement of the first participant, and wherein the longevity benefit payout is paid to the first participant only if the first participant is alive on the benefit payment date;
supplying to the processor, for the first participant, data representative of gender, date of birth, the assumed date of retirement, the estimated LBA, at least one desired longevity benefit payout by an LIP and at least one assumed benefit payment date for the desired longevity benefit payout; and
determining by the processor, based on (i) data representative of a current date, (ii) the data representative of the estimated premiums for longevity benefit payouts payable at benefit payment dates of the respective available LIPs at the assumed date of retirement in the database and (iii) the data representative of the estimated LBA, the assumed date of retirement, the desired longevity benefit payout and the assumed benefit payment date for the desired longevity benefit payout for the first participant, at least a first LIP from the database estimated to be available for purchase for the benefit of the first participant upon retirement.

6. The method of claim 5 further comprising:
supplying to the processor data representative of gender and date of birth of a beneficiary of the first participant; and
wherein the determining by the processor of the first LIP is further based on the data representative of the gender and the date of birth of the beneficiary, wherein the longevity benefit payout of the first LIP is payable by the first LIP to the beneficiary if the beneficiary is alive and the first participant is dead on the benefit payment date for the first LIP.

7. A computer-implemented method for selecting at least one longevity benefit payout payable to participants of a longevity benefit plan, wherein the plan includes a plurality of participants who are retired employees of at least one employer sponsoring the plan, the method comprising:
for each of the participants of the plan, the employer of the participant contributing employer contributions (“ECs”) to a trust of the plan, wherein a longevity benefit payout under the plan is to be paid from the trust;
crediting the trust with investment earnings on the amount held in the trust for each of the participants;
setting a longevity account balance (“LAB”) for at least a first participant upon retirement of the first participant from an employer sponsoring the plan for use in payment of a longevity benefit payout from the trust, wherein the LAB is computed by a processor from the sum of the ECs for the first participant and the credited investment earnings for the first participant as of the date the first participant retires;
providing a database of data representative of gender-based mortality information;
supplying to the processor, for the first participant, data representative of a date of birth, gender, the LAB, at least one desired allocation of the LAB and at least one desired benefit payment date for the desired allocation of the LAB, wherein the benefit payment date is a predetermined number of years after the date of retirement of the first participant; and
determining by the processor, based on (i) data representative of a current date, an assumed-rate of future investment return, and an estimated share of at least one retiree mortality gain (“RMG”) to be held in the trust on behalf of the first participant, wherein the RMG is a remaining amount of a LAB in the trust for a retired participant who died prior to a benefit payout date selected by the retired participant, (ii) the data representative of the mortality information and (iii) the data representative of the gender, the LAB, and the desired allocation of the LAB at the desired benefit payment date for the first participant, an expected longevity benefit payout to be paid from the trust at the desired benefit payment date, wherein the expected longevity benefit payout is paid to the first participant only if the first participant is alive on the benefit payment date.

8. The method of claim 7 further comprising:
supplying to the processor data representative of gender and date of birth of a beneficiary of the first participant; and
wherein the determining by the processor of the expected longevity benefit payout is further based on the data representative of the gender and the date of birth of the beneficiary, wherein the expected longevity benefit payout is payable to the beneficiary if the beneficiary is alive and the first participant is dead on the benefit payment date for the expected longevity benefit payout.

9. The method of claim 7 further comprising:
following payment of the expected longevity benefit payout to the first participant from the trust, determining by the processor of an accumulated cost to the employer for the first employee and supplying the accumulated cost to the employer;
wherein the accumulated cost is a function of an adjustment based on any portion of the RMG credited to the trust which corresponds to a cost basis for a retired participant who died prior to the benefit payment date for the retired participant,

10. The method of claim 9, wherein the accumulated cost is a function of an adjustment to the trust resulting from at least one of (i) a forfeiture of employer contributions for an employee who had been a participant of the plan but was terminated prior to the retirement of the participant, or (ii) an additional contribution to the plan by the employer to satisfy a specified annual rate of return for the plan.

11. An employer provided longevity insurance program comprising:
at least one trust for holding employer contributions (“ECs”) for respective participants in the program, wherein the trust includes a plurality of employees of at least one trust sponsor and provides a longevity benefit payout as selected by at least a first participant upon retirement of the first participant, wherein each of the participants is a retired employee or a non-terminated and unretired employee of at least one of the sponsors, wherein a longevity benefit accumulation (“LBA”) is computed by a processor from data in a database retrieved by the processor and representative of the ECs and investment earnings on the amount held in the trust for the first participant; and
wherein the LBA is available for use in funding a longevity benefit payout payable to the first participant at a benefit payment date which is a predetermined number of years after the date of retirement of the first participant, where the longevity benefit payout is paid to the first participant only if the first participant is alive on the benefit payment date.

12. The program of claim 11, wherein the LBA is used to pay a premium of a longevity insurance policy for paying the longevity benefit payout.

13. The program of claim 12, wherein a cash distribution from the LBA is made to the first participant if the longevity insurance policy is transferred to the first participant.

14. The program of claim 11, wherein the LBAs of a plurality of retired participants are used to fund an longevity benefit plan account LBA, wherein the account retains at least one retiree mortality gain (“RMG”), wherein the RMG is a remaining amount of an LBA in the account for a retired participant who died prior to a benefit payout date selected by the retired participant.

15. The program of claim 11, wherein the longevity benefit payout payable to the first participant at the benefit payment date is payable to a beneficiary of the first participant at the benefit payment date if the beneficiary is alive and the first participant is dead on the benefit payment date.

16. The program of claim 11, wherein the sponsor is an approved employer or an approved organization including employees.

17. A system for selecting at least one longevity insurance policy (“LIP”) having a longevity benefit payout payable to participants of a longevity benefit plan, wherein the plan includes a plurality of participants who are retired employees of at least one employer sponsoring the plan, the system comprising:
a processor for performing instructions stored in a computer-readable medium and using data stored in a database;
wherein the database includes data representative (i) for each of the participants of the plan, employer contributions (“ECs”) to an account of the plan held on behalf of the participant contributed by the employer of the participant, and (ii) investment earnings on the amount held in the plan account credited to the plan account for each of the participants;
wherein the instructions comprise:
setting a longevity benefit accumulation (“LBA”) for at least a first participant upon retirement of the first participant from an employer sponsoring the plan for use in purchase of an LIP, wherein the LBA is computed by the processor from the sum of the ECs for the first participant and the credited investment earnings for the first participant held in the plan account on behalf of the first participant as of the date the first participant retires;
retrieving by the processor of data representative of LIPs available for purchase and respective premiums, each of the LIPs having a longevity benefit payout payable at a benefit payment date, wherein the benefit payment date is a predetermined number of years after the retirement date of the first participant, and wherein the longevity benefit payout is paid to the first participant only if the first participant is alive on the benefit payment date for the LIP;
obtaining by the processor, for the first participant, data representative of gender, date of birth, the LBA, at least one desired longevity benefit payout by an LIP and at least one desired benefit payment date for the desired longevity benefit payout; and
determining by the processor, based on (i) data representative of a current date, (ii) the data representative of the premiums for longevity benefit payouts payable at benefit payment dates of the respective LIPs in the database and (iii) the data representative of the LBA, the date of birth, the gender, the desired longevity benefit payout and the desired benefit payment date for the desired longevity benefit payout for the first participant, at least a first LIP available from the database for purchase for the benefit of the first participant.

18. The system of claim 17, wherein the instructions further comprise:
obtaining by the processor of data representative of gender and date of birth of a beneficiary of the first participant; and
wherein the determining by the processor of the first LIP is further based on the data representative of the gender and the date of birth of the beneficiary, wherein the longevity benefit payout of the first LIP is payable by the first LIP to the beneficiary if the beneficiary is alive and the first participant is dead on the benefit payment date for the first LIP.

19. A system for selecting at least one longevity insurance policy (“LIP”) having an estimated longevity benefit payout payable to participants of a longevity benefit plan, wherein the plan includes a plurality of participants who are non-terminated and unretired employees of at least one employer sponsoring the plan, the system comprising:
a processor for performing instructions stored in a computer-readable medium and using data stored in a database;
wherein the database includes data representative (i) for each of the participants of the plan, employer contribution (“ECs”) to an account of the plan held on behalf of the participant contributed by the employer of the participant, and (ii) investment earnings on the amount held in the plan account credited to the plan account for each of the participants;
wherein the instructions comprise:
setting an estimated longevity benefit accumulation (“LBA”) for at least a first participant upon retirement of the first participant from an employee sponsoring the plan for use in purchase of an LIP, wherein the estimated LBA is computed by the processor from the sum of actual and estimated plan holdings for the first participant,
wherein the actual plan holdings is computed by the processor from the sum of the ECs for the first participant and the credited investment earnings for the first participant held in the plan account on behalf of the first participant as of the date the estimated LBA is set for the first participant, and
wherein the estimated plan holdings is computed by the processor from the sum of estimated ECs for the first participant and estimated credited investment earnings for the first participant from the date the estimated LBA is set to an assumed date of retirement for the first participant;
retrieving by the processor of data representative of LIPs estimated to be available for purchase at the assumed date of retirement for the first participant and respective estimated premiums, each of the LIPs having a longevity benefit payout payable at a benefit payment date, wherein the benefit payment date is a predetermined number of years after the assumed date of retirement of the first participant, and wherein the longevity benefit payout is paid to the first participant only if the first participant is alive on the benefit payment date;
obtaining by the processor, for the first participant, data representative of gender, date of birth, the assumed date of retirement, the estimated LBA, at least one desired longevity benefit payout by an LIP and at least one assumed benefit payment date for the desired longevity benefit payout; and
determining by the processor, based on (i) data representative of a current date, (ii) the data representative of the estimated premiums for longevity benefit payouts payable at benefit payment dates of the respective available LIPs at the assumed date of retirement in the database and (iii) the data representative of the estimated LBA, the assumed date of retirement, the desired longevity benefit payout and the assumed benefit payment date for the desired longevity benefit payout for the first participant, at least a first LIP from the database estimated to be available for purchase for the benefit of the first participant upon retirement.

20. The system of claim 19 further comprising:
obtaining by the processor of data representative of gender and date of birth of a beneficiary of the first participant; and
wherein the determining by the processor of the first LIP is further based on the data representative of the gender and the date of birth of the beneficiary, wherein the longevity benefit payout of the first LIP is payable by the first LIP to the beneficiary if the beneficiary is alive and the first participant is dead on the benefit payment date for the first LIP.

21. A system for selecting at least one longevity benefit payout payable to participants of a longevity benefit plan, wherein the plan includes a plurality of participants who are retired employees of at least one employer sponsoring the plan, the system comprising:
a processor for performing instructions stored in a computer-readable medium and using data stored in a database;
wherein the database includes data representative of (i) for each of the participants of the plan, employer contribution (“ECs”) to a trust of the plan contributed by the employer of the participant, wherein a longevity benefit payout under the plan is to be paid from the trust, and (ii) investment earnings on the amount held in the trust for each of the participants credited to the trust;
wherein the instructions comprise:
setting a longevity account balance (“LAB”) for at least a first participant upon retirement of the first participant from an employer sponsoring the plan for use in payment of a longevity benefit payout from the trust, wherein the LAB is computed by the processor from the sum of the ECs for the first participant and the credited investment earnings for the first participant as of the date the first participant retires;
retrieving by the processor of data representative of gender-based mortality information;
obtaining by the processor, for the first participant, data representative of a date of birth, gender, the LAB, at least one desired allocation of the LAB and at least one desired benefit payment date for the desired allocation of the LAB, wherein the benefit payment date is a predetermined number of years after the date of retirement of the first participant; and
determining by the processor, based on (i) data representative of a current date, an assumed rate of future investment return, and an estimated share of at least one retiree mortality gain (“RMG”) to be held in the trust on behalf of the first participant, wherein the RMG is a remaining amount of a LAB in the trust for a retired participant who died prior to a benefit payout date selected by the retired participant, (ii) the data representative of the mortality information and (iii) the data representative of the gender, the LAB, and the desired allocation of the LAB at the desired benefit payment date for the first participant, an expected longevity benefit payout to be paid from the trust at the desired benefit payment date, wherein the expected longevity benefit payout is paid to the first participant only if the first participant is alive on the benefit payment date.

22. The system of claim 11, wherein the instructions further comprise:
obtaining by the processor of data representative of gender and date of birth of a beneficiary of the first participant; and
wherein the determining by the processor of the expected longevity benefit payout is further based on the data representative of the gender and the date of birth of the beneficiary, wherein the expected longevity benefit payout is payable to the beneficiary if the beneficiary is alive and the first participant is dead on the benefit payment date for the expected longevity benefit payout.

23. A computer-implemented method for selecting at least one longevity insurance policy (“LIP”) having a longevity benefit payout payable to participants of a longevity benefit plan, wherein the plan includes a plurality of participants who are members of at least one organization sponsoring the plan, the method comprising:
each of the participants of the plan contributing contributions to a respective account of the plan held on behalf of the participant;
crediting the plan account for each of the participants with investment earnings on the amount held in the plan account;
setting a longevity benefit accumulation (“LBA”) for at least a first participant, upon the first participant satisfying an age-related criteria, for use in purchase of an LIP, wherein the LBA is computed by a processor from the sum of the contributions for the first participant and the credited investment earnings for the first participant held in the plan account on behalf of the first participant as of the date the first participant satisfies the age-related criteria;
providing a database of data representative of LIPs available for purchase and respective premiums, each of the LIPs having a longevity benefit payout payable at a benefit payment date, wherein the benefit payment date is a predetermined number of years after the first participant satisfies the age-related criteria, and wherein the longevity benefit payout is paid to the first participant only if the first participant is alive on the benefit payment date for the LIP;
supplying to the processor, for the first participant, data representative of gender, date of birth, the LBA, at least one desired longevity benefit payout by an LIP and at least one desired benefit payment date for the desired longevity benefit payout; and
determining by the processor, based on (i) data representative of a current date, (ii) the data representative of the premiums for longevity benefit payouts payable at benefit payment dates of the respective LIPs in the database and (iii) the data representative of the LBA, the date of birth, the gender, the desired longevity benefit payout and the desired benefit payment date for the desired longevity benefit payout for the first participant, at least a first LIP available from the database for purchase for the benefit of the first participant.

24. A computer-implemented method for selecting at least one longevity benefit payout payable to participants of a longevity benefit plan, wherein the plan includes a plurality of participants who are members of at least one organization sponsoring the plan, the method comprising:
the participants of the plan contributing contributions to a trust of the plan for the benefit of the participants, wherein a longevity benefit payout under the plan is to be paid from the trust;
crediting the trust with investment earnings on the amount held in the trust for each of the participants;
setting a longevity account balance (“LAB”) for at least a first participant upon the first participant satisfying an age-related criteria for use in payment of a longevity benefit payout from the trust, wherein the LAB is computed by a processor from the sum of the contributions for the first participant and the credited investment earnings for the first participant as of the date the first participant satisfies the age-related criteria;
providing a database of data representative of gender-based mortality information;
supplying to the processor, for the first participant, data representative of a date of birth, gender, the LAB, at least one desired allocation of the LAB and at least one desired benefit payment date for the desired allocation of the LAB, wherein the benefit payment date is a predetermined number of years after the first participant satisfies the age-related criteria; and
determining by the processor, based on (i) data representative of a current date, an assumed rate of future investment return, and an estimated share of at least one mortality gain (“MG”) to be held in the trust on behalf of the first participant, wherein the MG is a remaining amount of a LAB in the trust for a qualifying participant who died prior to a benefit payout date selected by the qualifying participant, (ii) the data representative of the mortality information and (iii) the data representative of the gender, the LAB, and the desired allocation of the LAB at the desired benefit payment date for the first participant, an expected longevity benefit payout to be paid from the trust at the desired benefit payment date, wherein the expected longevity benefit payout is paid to the first participant only if the first participant is alive on the benefit payment date.

25. A system for selecting at least one longevity insurance policy (“LIP”) having a longevity benefit payout payable to participants of a longevity benefit plan, wherein the plan includes a plurality of participants who are members of at least one organization sponsoring the plan, the system comprising:
a processor for performing instructions stored in a computer-readable medium and using data stored in a database;
wherein the database includes data representative (i) for each of the participants of the plan, contributions to an account of the plan held on behalf of the participant contributed by the participant, and (ii) investment earnings on the amount held in the plan account credited to the plan account for each of the participants;
wherein the instructions comprise:
setting a longevity benefit accumulation (“LBA”) for at least a first participant upon the first participant satisfying an age-related criteria for use in purchase of an LIP, wherein the LBA is computed by the processor from the sum of the contributions for the first participant and the credited investment earnings for the first participant held in the plan account on behalf of the first participant as of the date the first participant satisfies the age-related criteria;
retrieving by the processor of data representative of LIPs available for purchase and respective premiums, each of the LIPs having a longevity benefit payout payable at a benefit payment date, wherein the benefit payment date is a predetermined number of years after the first participant satisfies the age-related criteria, and wherein the longevity benefit payout is paid to the first participant only if the first participant is alive on the benefit payment date for the LIP;
obtaining by the processor, for the first participant, data representative of gender, date of birth, the LBA, at least one desired longevity benefit payout by an LIP and at least one desired benefit payment date for the desired longevity benefit payout; and
determining by the processor, based on (i) data representative of a current date, (ii) the data representative of the premiums for longevity benefit payouts payable at benefit payment dates of the respective LIPs in the database and (iii) the data representative of the LBA, the date of birth, the gender, the desired longevity benefit payout and the desired benefit payment date for the desired longevity benefit payout for the first participant, at least a first LIP available from the database for purchase for the benefit of the first participant.

26. A system for selecting at least one longevity benefit payout payable to participants of a longevity benefit plan, wherein the plan includes a plurality of participants who are members of at least one organization sponsoring the plan, the system comprising:
a processor for performing instructions stored in a computer-readable medium and using data stored in a database;
wherein the database includes data representative of (i) for each of the participants of the plan, contributions to a trust of the plan contributed by the participant, wherein a longevity benefit payout under the plan is to be paid from the trust, and (ii) investment earnings on the amount held in the trust for each of the participants credited to the trust;
wherein the instructions comprise:
setting a longevity account balance (“LAB”) for at least a first participant upon the first participant satisfying an age-related criteria for use in payment of a longevity benefit payout from the trust, wherein the LAB is computed by the processor from the sum of the contributions for the first participant and the credited investment earnings for the first participant as of the date the first participant satisfies the age-related criteria;
retrieving by the processor of data representative of gender-based mortality information;
obtaining by the processor, for the first participant, data representative of a date of birth, gender, the LAB, at least one desired allocation of the LAB and at least one desired benefit payment date for the desired allocation of the LAB, wherein the benefit payment date is a predetermined number of years after the date of the first participant satisfies the age-related criteria; and
determining by the processor, based on (i) data representative of a current date, an assumed rate of future investment return, and an estimated share of at least one mortality gain (“MG”) to be held in the trust on behalf of the first participant, wherein the MG is a remaining amount of a LAB in the trust for a qualifying participant who died prior to a benefit payout date selected by the qualifying participant, (ii) the data representative of the mortality information and (iii) the data representative of the gender, the LAB, and the desired allocation of the LAB at the desired benefit payment date for the first participant, an expected longevity benefit payout to be paid from the trust at the desired benefit payment date, wherein the expected longevity benefit payout is paid to the first participant only if the first participant is alive on the benefit payment date.
